(19) United States
(12) Patent Application Publication
(10) Pub. No.: US 2013/0280558 A1
(43) Pub. Date: Oct. 24, 2013

(54) RECHARGEABLE BATTERY

(71) Applicants: Jong-Hwa HUR, Yongin-si (KR); Sang-Do HEO, Yongin-si (KR)

(72) Inventors: Jong-Hwa HUR, Yongin-si (KR); Sang-Do HEO, Yongin-si (KR)

(73) Assignee: SAMSUNG SDI CO., LTD., Yongin-si (KR)

(21) Appl. No.: 13/618,706

(22) Filed: Sep. 14, 2012

Related U.S. Application Data
(60) Provisional application No. 61/635,543, filed on Apr. 19, 2012.
(60) Provisional application No. 61/653,896, filed on May 31, 2012.

(51) Int. Cl. H01M 10/42

(52) U.S. Cl. CPC H01M 10/4257
USPC 429/7

(57) ABSTRACT

A rechargeable battery that includes an electrode assembly, a case having an inner space and receiving the electrode assembly, and a protective circuit module mounted with a protective element controlling charge and discharge of the electrode assembly, wherein the protective circuit module includes a circuit board installed with the protective element and a metal part fixed to the circuit board and combined to the case.

### CLAIM OF PRIORITY

This application claims priority under 35 U.S.C. §119(e) to U.S. Provisional Application No. 61/635,543, filed on 19 Apr. 2012, which is herein incorporated by reference in its entirety. Furthermore, the present application is related to a co-pending U.S. application Ser. No. (to be assigned), entitled RECHARGEABLE BATTERY PACK, based upon to U.S. Provisional Application No. 61/653,896 filed on 31 May 2012, and filed in the U.S. Patent & Trademark Office concurrently with the present application.

### BACKGROUND OF THE INVENTION

1. Field of the Invention

The described technology relates generally to a rechargeable battery including a protective circuit module.

2. Description of the Related Art

Unlike a primary battery that is incapable of being recharged, a rechargeable battery can be repeatedly charged and discharged. A low capacity rechargeable battery has been used for small electronic devices such as a mobile phone, a laptop computer, and a camcorder, and a large capacity battery has been widely used as a power source for driving a motor of a hybrid vehicle.

A representative rechargeable battery includes a nickel-cadmium (Ni—Cd) battery, a nickel-hydrogen (Ni—MH) battery, a lithium (Li) battery, and a lithium ion (Li-ion) rechargeable battery. Particularly, the lithium ion secondary battery has a higher operation voltage by about three times than either of the nickel-cadmium battery or the nickel-hydrogen battery that are mainly used as a portable electric equipment power source. Also, the lithium ion secondary battery has a high energy density per unit weight ratio.

The rechargeable battery mainly uses a lithium-based oxide as a positive active material and a carbon material as a negative active material. In general, the rechargeable battery is classified into a liquid electrolyte battery and a polymer electrolyte battery according to a kind of an electrolyte, and the battery using the liquid electrolyte is referred to as a lithium ion battery, while the battery using the polymer electrolyte is referred to as a lithium polymer battery.

This rechargeable battery includes a protective circuit module that controls charge and discharge. The protective circuit module prevents an overcharge and an over-discharge of the rechargeable battery, thereby improving safety and cycle-life of the rechargeable battery. To mount the protective circuit module to the rechargeable battery, a protective circuit substrate must be enclosed and fixed by using an insulator and a tab case such that the number of elements is increased and an assembly process is complicated.

The above information disclosed in this Background section is only for enhancement of understanding of the background of the described technology and therefore it may contain information that may not constitute prior art as per 35 U.S.C. §102.

### SUMMARY OF THE INVENTION

The present invention provides a rechargeable battery simplifying an assembly process.

According to one aspect of the present invention, there is provided a rechargeable battery that includes a case, an electrode assembly arranged within the case; and a protective circuit module borne by an opening in the case to seal the electrode assembly within the case, the protective circuit module including a circuit substrate including a printed circuit board and an electronic component arranged on the printed circuit board and a metal layer borne by the circuit substrate, wherein a peripheral portion of the metal layer is attached to the case to seal the electrode assembly within. The rechargeable battery may also include a resin layer arranged between the electrode assembly and each of the circuit substrate and the metal layer. The electronic component may face the electrode assembly. The resin layer may cover the electronic component. The rechargeable battery may also include lead tabs extending from the electrode assembly and through the resin layer. The protective circuit module may be perforated by an electrolyte solution injecting aperture. The resin layer may be perforated by an electrolyte solution injecting aperture at a location corresponding to a location of the electrolyte solution injecting aperture that perforates the protective circuit module. The metal layer may have a plate shape and be comprised of a same material as the case. The metal layer may be welded to the case.

The electronic component may be an integrated circuit (IC) chip arranged on a side of the circuit substrate facing the electrode assembly, the electronic component may be arranged within the case and be covered by the resin layer. The circuit substrate may include a first plate and a second plate, the metal layer may be arranged between the first plate and the second plate, the first plate and the second plate may each be printed circuit boards. The metal layer may extend along a length of the circuit substrate from beyond a first end of the first and second plates to beyond a second end of the first and second plates. The metal layer may be arranged only at a periphery of the circuit substrate and have a supporting part inserted into sidewalls of the circuit substrate and a protruding part extending to an outside of sidewalls of end portions of the circuit substrate.

The metal layer may be arranged on a top side of the circuit substrate, the metal layer may extend along a length of the circuit substrate from beyond a first end of the circuit substrate to beyond a second end of the circuit substrate. The rechargeable battery may also include an outer terminal arranged on a top side of the circuit substrate to connect to an external device, the metal layer may have an aperture in a vicinity of the outer terminal to prevent electrical connection to the outer terminal.

The circuit substrate may include a lower molding part arranged on a bottom side of the metal layer and an upper molding part arranged on a top side of the metal layer, the metal layer may have an opening corresponding to outer terminals of the rechargeable battery. The metal layer may protrude from end sidewalls of the upper and lower molding parts. The metal layer may be arranged on a lower side of the circuit substrate and be arranged only at a periphery of the circuit substrate.

According to another aspect of the present invention, there is provided a rechargeable battery that includes a case, an electrode assembly arranged within the case; and, a protective circuit module joined with an opening in the case, the protective circuit module including a circuit substrate including a printed circuit board including electrical traces arranged thereon and a protective element IC chip arranged on the printed circuit board and a metal layer joined to the circuit substrate. The rechargeable battery may also include a resin layer arranged between the electrode assembly and the protective circuit module and covering the protective element IC chip.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view of a rechargeable battery according to a first exemplary embodiment of the present invention;

FIG. 2 is a perspective view of a rechargeable battery according to the first exemplary embodiment of the present invention;

FIG. 3 is a cross-sectional view taken along the line of FIG. 2;

FIG. 4 is a cross-sectional view of a protective circuit module according to the first exemplary embodiment of the present invention;

FIG. 5 is a cross-sectional view of a protective circuit module according to a second exemplary embodiment of the present invention;

FIG. 6 is a cross-sectional view of a protective circuit module according to a third exemplary embodiment of the present invention;

FIG. 7 is a cross-sectional view of a rechargeable battery according to the third exemplary embodiment of the present invention;

FIG. 8 is a cross-sectional view of a protective circuit module according to an exemplary variation of the third exemplary embodiment of the present invention;

FIG. 9 is a cross-sectional view of a protective circuit module according to a fourth exemplary embodiment of the present invention;

FIG. 10 is a cross-sectional view of a protective circuit module according to a fifth exemplary embodiment of the present invention; and

FIG. 11 is an exploded perspective view of a rechargeable battery according to the fifth exemplary embodiment of the present invention.

### DETAILED DESCRIPTION OF THE INVENTION

Hereinafter, exemplary embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention. Like reference numerals designate like elements throughout the specification.

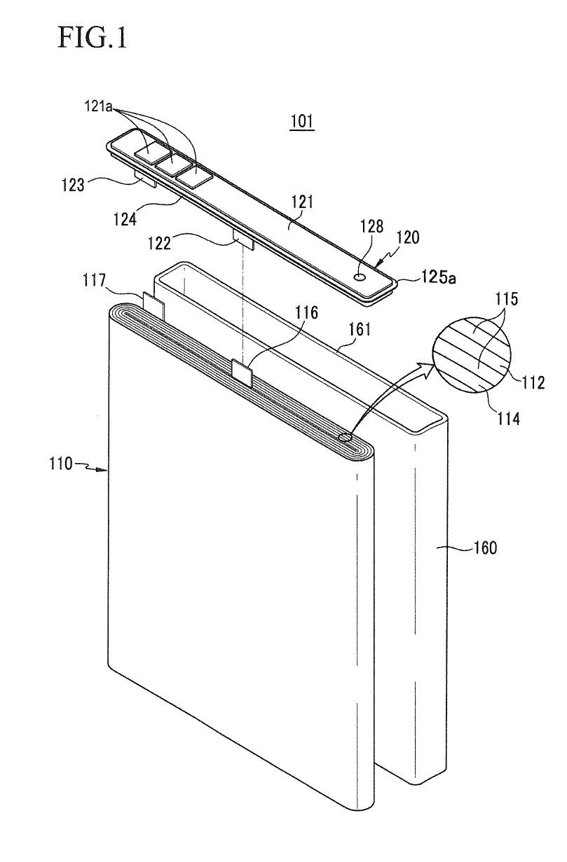

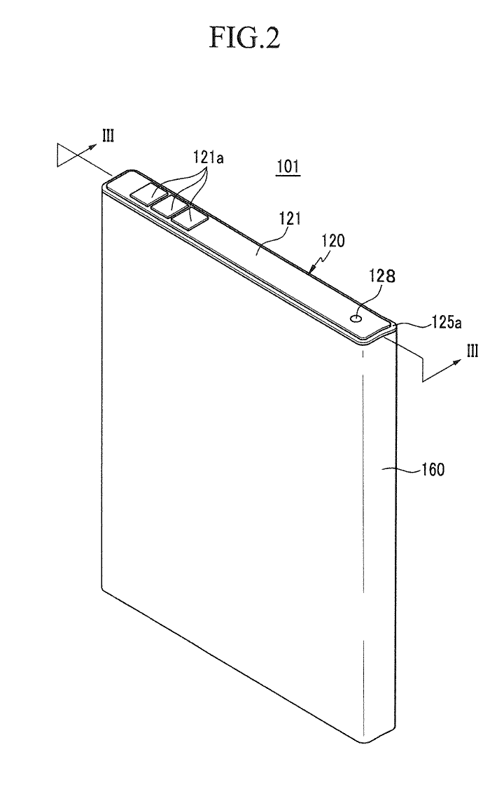

Turning now to FIGS. 1 and 2, FIG. 1 is an exploded perspective view of a rechargeable battery 101 according to the first exemplary embodiment of the present invention and FIG. 2 is a perspective view of the rechargeable battery 101 according to the first exemplary embodiment of the present invention. Referring to FIGS. 1 and 2, the rechargeable battery 101 according to the first exemplary embodiment includes an electrode assembly 110, a protective circuit module 120, and a case 160 connected to the protective circuit module 120.

The electrode assembly 110 is a spirally wound laminate, the laminate including a separator 115 is interposed between a positive electrode 112 and a negative electrode 114, however, the present invention is not limited thereto as the electrode assembly may instead be formed in a structure in which the positive electrode and the negative electrode are deposited via the separator interposed therebetween. A positive electrode tab 116 is attached to the positive electrode 112 and a negative electrode tab 117 is attached to the negative electrode 114.

The protective circuit module 120 is attached to an opening in the case 160 to seal the electrode assembly 110 within. The protective circuit module 120 includes a circuit board 121, a first lead tab 122, and a second lead tab 123. The circuit board 121 is a printed circuit board on which a wiring pattern is printed. The circuit board 121 has a rectangular thin plate shape extending lengthwise in one direction. The protective circuit module 120 is connected to the electrode assembly 110 to control an operation of the electrode assembly 110 including charging and discharging operations.

The first lead tab 122 may be made out of an electrically conductive material such as nickel and may be electrically connected to the circuit board 121. The first lead tab 122 electrically connects the circuit board 121 to the electrode assembly 110 and is installed at the center of a first surface 121c of the circuit board 121. The first lead tab 122 is connected to the positive electrode tab 116 of the electrode assembly 110 by welding.

The second lead tab 123 is positioned at one end of the length direction of the circuit board 121 and electrically connects the circuit board 121 to the electrode assembly 110. The second lead tab 123 is also made out of an electrically conductive material such as nickel and is connected to the negative electrode tab 117 by welding.

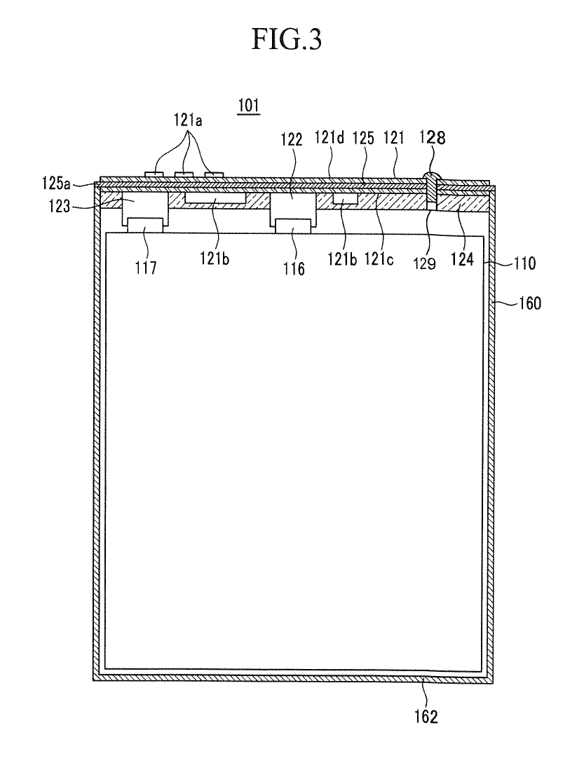

Turning now to FIG. 3, the protective circuit module 120 further includes a protective element 121b mounted to the first surface 121c of the circuit board 121. The protective element 121b may be a control IC, and is an element such as a charge and discharge switch. Here, the first surface 121c is a surface facing the electrode assembly 110. Also, an outer terminal 121a is electrically connected to an external load or a charger and is provided at a second surface 121d of the circuit board 121.

A metal part 125a formed along a circumference direction of the circuit board 121 is formed as the edge or periphery of the protective circuit module 120. The circuit board 121 is of the rectangular plate shape, and the metal part 125a protrudes from the side ends of the circuit board 121 to the outside thereby forming an approximate rectangular shape while surrounding a periphery of the circuit board 121. The metal part 125a is attached to the case 160 about the opening 161 by welding, thereby sealing the case 160.

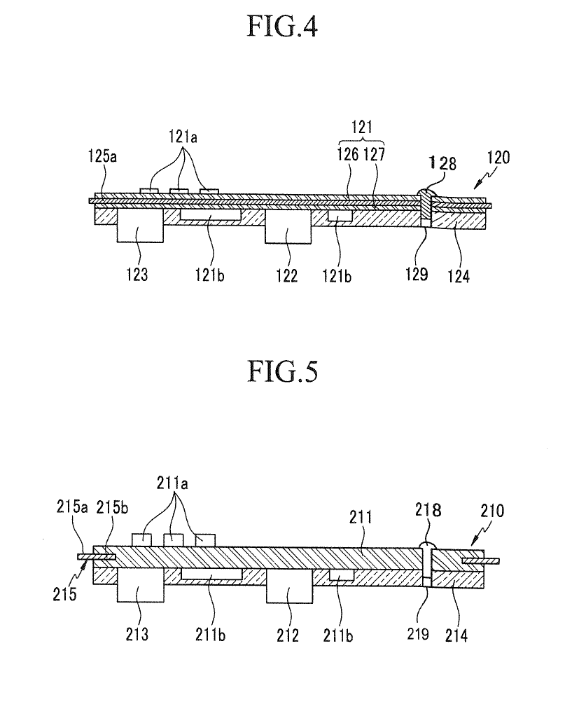

Turning now to FIG. 4, the protective circuit module 120 further includes a first plate 126 disposed at an upper side, a second plate 127 disposed under the first plate 126, and the metal member 125 having a plate shape disposed between the first plate 126 and the second plate 127. The first plate 126 and the second plate 127 are disposed to face to each other, and the metal member 125 is inserted and disposed between the first plate 126 and the second plate 127. Here, the first plate 126 and the second plate 127 become the circuit board 121.

The metal member 125 is inserted between the first plate 126 and the second plate 127 in the manufacturing process of the circuit board 121, and is integrally formed with the circuit board 121. The metal member 125 is made out of the same material as the case 160, and the metal member 125 according to the present exemplary embodiment may be made out of aluminum. The metal part 125a is integrally formed with the metal member 125 and is formed according to the side ends of the metal member 125.

Also, the protective circuit module 120 includes the protective element 121b and a resin layer 124 covering a lower surface 121c of the circuit board 121. The resin layer 124 is formed by insert molding, and is formed on the lower surface 121c of the circuit board 121 prior to when the protective circuit module 120 is attached to either the case 160 or the electrode assembly 110. The resin layer covers the protective element 121b and the lower surface 121c of the circuit board 121 in a state when the circuit board 121 is installed. In the present invention, the resin layer 124 as well as the protective element 121b are arranged within the case 160, and so the resin layer 124 serves to prevent the protective element 121b from being exposed to the electrolyte. The first lead tab 122 and the second lead tab 123 are installed to protrude under the resin layer 124, and the metal part 125a is installed to protrude further to the outside than the resin layer 124.

Meanwhile, the protective circuit module 120 further includes an electrolyte solution injecting inlet 129 for injecting the electrolyte solution, and the electrolyte solution injecting inlet 129 is formed to pass through the circuit board 121 and the resin layer 124. The electrolyte solution injecting inlet 129 is installed with a sealing valve 128 sealing the electrolyte solution injecting inlet 129.

The case 160 includes a space receiving the electrode assembly 110, and the opening 161 is formed at the upper portion. The case 160 may have a cuboid shape having a bottom 162 opposite opening 161. Also, the case 160 may be made out of a metal material, such as a metal that includes aluminum.

The opening 161 into which the electrode assembly 110 is inserted is formed at the upper end of the case 160, and the metal part 125a is combined with the opening 161. The metal part 125a and the case 160 are both made out of the same metal material that may include aluminum so that the metal part 125a can be easily welded to the case 160, thereby stably sealing the case 160.

In the present exemplary embodiment, the protective circuit module 120 is integrally formed when forming the resin layer 124 such that the assembly of the protective circuit module 120 and the case 160 may be simplified, and the protective element 121b and the circuit board 121 may be stably protected from the electrolyte solution. Also, if the metal part 125a is combined to the case 160 by the welding, the case 160 is stably sealed such that leakage of the inner electrolyte solution may be prevented.

Turning now to FIG. 5, FIG. 5 is a cross-sectional view of a protective circuit module 210 according to the second exemplary embodiment of the present invention. Referring to FIG. 5, a rechargeable battery according to the second exemplary embodiment is formed to have the same the structure as that of the rechargeable battery of the first exemplary embodiment except for the structure of a protective circuit module 210 such that the overlapping description is omitted. The protective circuit module 210 according to the second exemplary embodiment includes a circuit board 211 and a metal member 215 inserted in side ends of the circuit board 211.

A first lead tab 212, a second lead tab 213, an outer terminal 211a, and a protective element 211b are installed at the circuit board 211. The metal member 215 includes a metal part 215a protruding outside the circuit board 211 and a supporting part 215b inserted into the circuit board 211. The metal member 215 is inserted and installed toward the inner portion from end sidewalls of the circuit board 211.

The circuit board 211 has as approximate rectangle shape and the metal member 215 has a rectangular shape and surrounds the circuit board 211. The metal part 215a is formed along the circumference of the circuit board 211 and protrudes outside along the side ends of the circuit board 211. The metal member 215 is installed to be partially inserted into the circuit board 211 in the manufacturing process of the circuit board 211. The metal part 215a is fixed to the opening of the case 160 by a technique such as welding or melting to close and seal the case 160.

Also, the protective circuit module 210 includes a resin layer 214 covering the protective element 211b and the lower surface of the circuit board 211. The resin layer 214 is formed by insert molding, and the resin layer 214 covers the protective element 211b and the lower surface of the circuit board 211 when installing the circuit board 211. The first lead tab 212 and the second lead tab 213 installed in the circuit board 211 protrude under the resin layer 214, and the metal part 215a is installed to protrude further to the side ends than the resin layer 214.

Meanwhile, the protective circuit module 210 includes an electrolyte solution injecting inlet 219 for injecting the electrolyte solution, and the electrolyte solution injecting inlet 219 passes through the circuit board 211 and the resin layer 214. The electrolyte solution injecting inlet 219 is filled with a sealing valve 218 sealing the electrolyte solution injecting inlet 219.

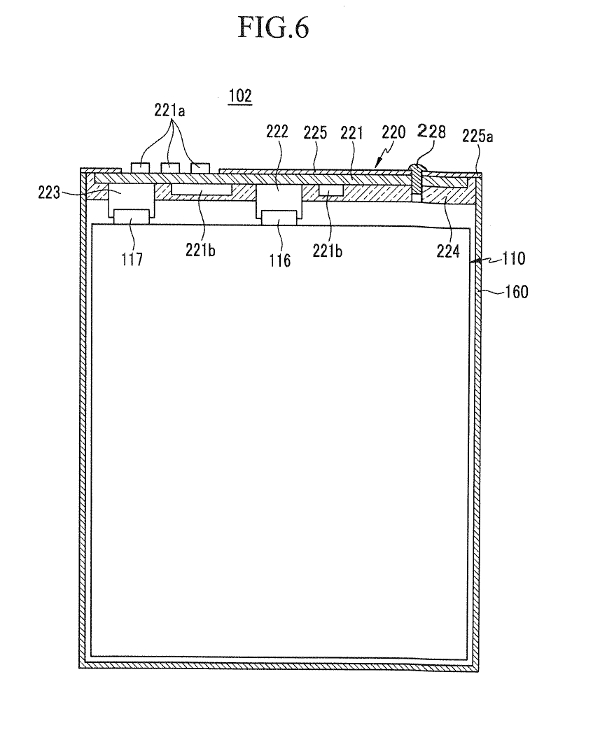

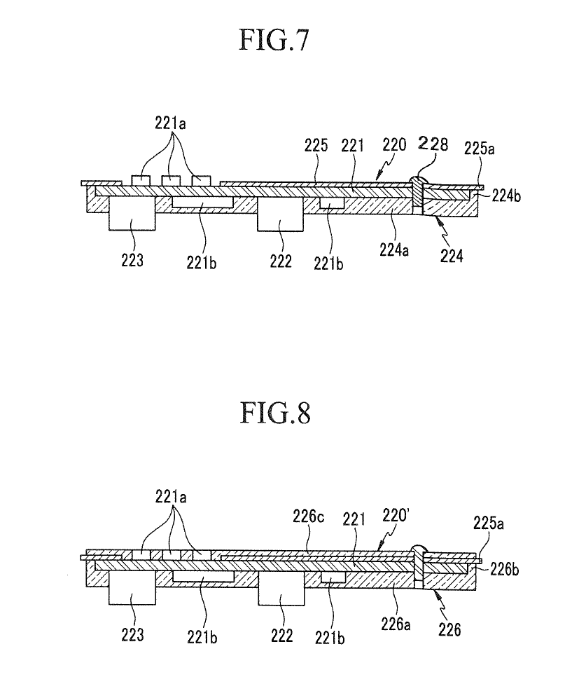

Turning now to FIG. 6, FIG. 6 is a cross-sectional view of a rechargeable battery 102 that includes a protective circuit module 220 according to the third exemplary embodiment of the present invention, and FIG. 7 is a cross-sectional view of the protective circuit module 220 according to the third exemplary embodiment of the present invention.

Referring now to FIGS. 6 and 7, the rechargeable battery 102 according to the third exemplary embodiment includes an electrode assembly 110, a protective circuit module 220, and a case 160 connected to the protective circuit module 220. The rechargeable battery 102 according to the third exemplary embodiment is formed with the same structure as the rechargeable battery of the first exemplary embodiment except for the protective circuit module 220 such that the overlapping description is omitted.

The protective circuit module 220 according to the third exemplary embodiment includes a circuit board 221 and a metal member 225 combined to the circuit board 221. A first lead tab 222, a second lead tab 223, a protective element 221b, and an outer terminal 221a are installed to the circuit board 221.

The metal member 225 has a plate shape and is fixed to a top surface of the circuit board 221, which is exposed to an outside of the rechargeable battery 102. The metal member 225 has a metal part 225a protruding outside the circuit board 221.

The circuit board 221 has an approximate rectangle shape, and the metal part 225a is arranged along the circumference of the circuit board 221 and protrudes outside along the side end of the circuit board 221. The metal member 225 is fixed to the circuit board 221 by a method such as melting, and a buffer layer for insulating may be formed between the circuit board 221 and the metal member 225.

Also, the protective circuit module 220 includes a resin layer 224 covering the protective element 221b on the lower surface of the circuit board 221. The resin layer 224 is formed by insert molding, and the resin layer 224 covers the protective element 221b, the lower surface and the side surfaces of the circuit board 221 in a state of installing the circuit board 221.

The resin layer 224 has a lower molding part 224a covering the lower surface of the circuit board 221 and a side molding part 224b protruded upward from the lower molding part 224a and enclosing the side surfaces of the circuit board 221. Accordingly, the protective element 221b and the circuit board 221 may be stably protected by the resin layer 224.

The first lead tab 222 and the second lead tab 223 connected and installed to the circuit board 221 protrude under the resin layer 224, the first lead tab 222 is connected to the positive electrode tab 116, and the second lead tab 223 is connected to the negative electrode tab 117.

The metal part 225a is installed to protrude further outside than the resin layer 224 and is fixed to the opening of the case 160 by a method such as the welding or melting to close and seal the case 160. Meanwhile, the protective circuit module 220 includes a sealing valve 228 sealing the electrolyte solution injecting inlet after injecting the electrolyte solution.

Turning now to FIG. 8, FIG. 8 is a cross-sectional view of a protective circuit module 220′ according to a variation of the third exemplary embodiment of the present invention. The rechargeable battery according to the variation of FIG. 8 has the same structure as the rechargeable battery according to the third exemplary embodiment except for the structure of a resin layer 226 such that the overlapping description is omitted.

A protective circuit module 220′ includes a resin layer 226 covering a protective element 221b and a circuit board 221. The resin layer 226 is formed by insert molding and encloses the protective element 221b and the circuit board 221 in the state of installing the circuit board 221.

The resin layer 226 includes a lower molding part 226a covering the lower surface of the circuit board 221, a side molding part 226b protruded upward from the lower molding part 226a and covering the side surfaces of the circuit board 221, and an upper molding part 226c formed on the side molding part 226b and covering the upper surface of the circuit board 221. The upper molding part 226c includes a hole such that the outer terminal 221a is exposed to the outside. The variation protective circuit module 220′ of FIG. 8 differs from that of protective circuit module 220 of FIGS. 6 and 7 in that the protective circuit module 220′ of FIG. 8 further includes the upper molding part 226c on a top side of metal member 225. In the protective circuit module 220′ of FIG. 8, the resin layer 226 is installed to totally enclose the circuit board 221 such that the protective element 221b and the circuit board 221 may be further stably protected.

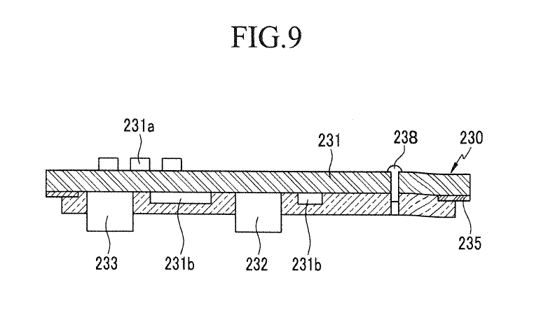

Turning now to FIG. 9, FIG. 9 is a cross-sectional view of a protective circuit module 230 according to the fourth exemplary embodiment of the present invention. Referring now to FIG. 9, the rechargeable battery according to the fourth exemplary embodiment has the same structure as the rechargeable battery according to the first exemplary embodiment except for a protective circuit module 230 such that the overlapping description is omitted.

The protective circuit module 230 according to the fourth exemplary embodiment includes a circuit board 231 and a metal part 235 formed with a pattern shape on the bottom surface of the circuit board 231. A first lead tab 232, a second lead tab 233, a protective element 231b, and an outer terminal 231a are installed at the circuit board 231.

The circuit board 231 has an approximate rectangular shape and the metal part 235 has a quadrangular shape around a periphery of the circuit board 231. The metal part 235 is formed along the circumference of the circuit board 231, meets the outer periphery of the circuit board 231, and is fixed under the side end of the circuit board 231. The metal part 235 is also fixed to the opening of the case 160 by a technique such as melting to close and seal the case 160. The metal part 235 may be produced of a pattern etched in the manufacturing process of the circuit board 231 or may be produced by combining a thin metal plate to the circuit board 231.

Also, the protective circuit module 230 includes the protective element 231b and a resin layer 234 covering the lower surface of the circuit board 231. The resin layer 234 is formed by insert molding, and the resin layer 234 is arranged to cover the protective element 231b and the lower and side surfaces of the circuit board 231 in a state of installing the circuit board 231.

The first lead tab 232 and the second lead tab 233 are installed in the circuit board 231 and protrude under the resin layer 234. The metal part 235 is partially covered by the resin layer 234 and protrudes further outside than the resin layer 234 thereby having an exposed portion. The exposed metal part 235 is fixed to the opening of the case 160 by a technique such as welding or melting to close and seal the case 160. Meanwhile, the protective circuit module 230 includes a sealing valve 238 sealing the electrolyte solution injecting inlet after injecting the electrolyte solution.

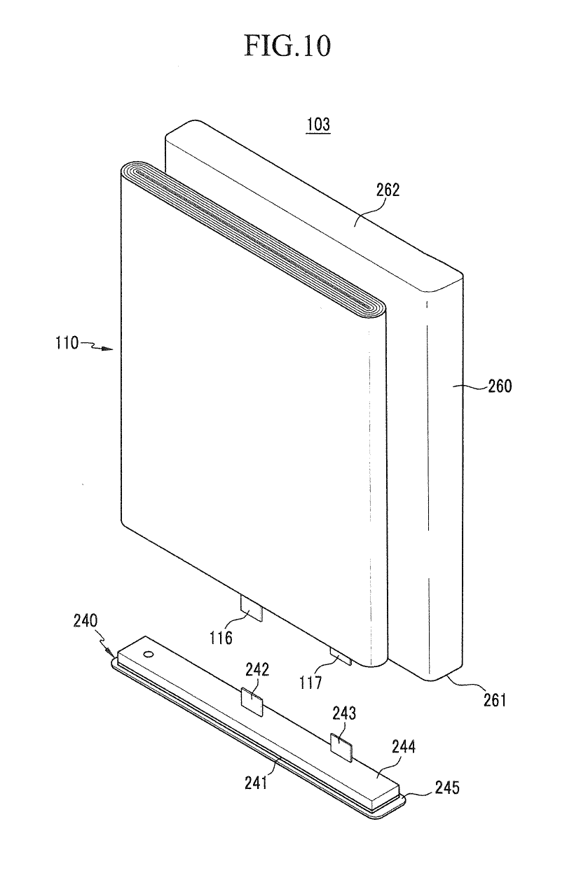

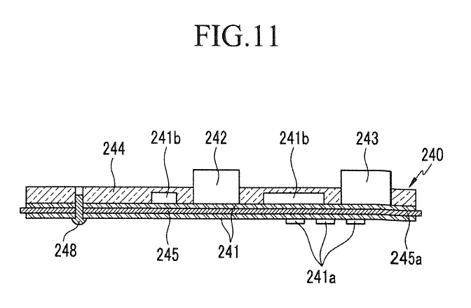

Turning now to FIGS. 10 and 11, FIG. 10 is a cross-sectional view of a rechargeable battery 103 according to the fifth exemplary embodiment of the present invention, and FIG. 11 is an exploded perspective view of a protective circuit module 240 according to the fifth exemplary embodiment of the present invention. Referring now to FIGS. 10 and 11, a rechargeable battery 103 according to the fifth exemplary embodiment includes an electrode assembly 110, the protective circuit module 240, and a case 260 combined to the protective circuit module 240.

The electrode assembly 110 according to the fifth exemplary embodiment is formed the same as the electrode assembly according to the first exemplary embodiment such that the overlapping description is omitted.

The case 260 has a space for receiving the electrode assembly 110, and includes an opening 261 that is opened at the lower portion. The case 260 is formed of a cuboid shape having a ceiling part 262. Also, the case 260 is made out of a metal material such as aluminum.

The protective circuit module 240 according to the fifth exemplary embodiment includes a circuit board 241 and a metal member 245 inserted to the circuit board 241. The metal member 245 is inserted between two plates that constitute the circuit board 241 in the manufacturing process of the circuit board 241, thereby being integrally formed with the circuit board 241. The metal member 245 is formed with the same material as the case 260, and the metal member 245 according to the fifth exemplary embodiment may be made out of aluminum.

The metal member 245 has a plate shape and has a metal part 245a protruding outside the circuit board 241. The metal part 245a is integrally formed with the metal member 245 and is arranged along the side end of the metal member 245. The circuit board 241 has an approximate rectangular shape, and the metal part 245a is formed along the periphery of the circuit board 241 and protrudes further outside than the side ends of the circuit board 241.

The metal part 245a is fixed to the opening 261 of the case 260 by a technique such as welding or melting to close and seal the case 260. In the fifth exemplary embodiment, the opening 261 is arranged under the case 260 such that the protective circuit module 240 seals the case 260 under the case 260 so the case 260 may be stably sealed without an additional cover.

Also, the protective circuit module 240 includes the protective element 241b and a resin layer 244 covering the upper surface of the circuit board 241. The resin layer 244 is formed via an insert molding technique, and the resin layer 244 is molded to cover the protective element 241b and the upper surface of the circuit board 241 in the state of installing the circuit board 241.

The circuit board 241 is installed with a first lead tab 242, a second lead tab 243, a protective element 241b, and an outer terminal 241a. The first lead tab 242 and the second lead tab 243 connected and installed to the circuit board 241 protrude from the resin layer 244, the first lead tab 242 being connected to the positive electrode tab 116, and the second lead tab 243 being connected to the negative electrode tab 117.

The metal part 245a is installed to protrude further outside than the resin layer 244 and is fixed to the opening of the case 260 by a technique such as welding or melting to close and seal the case 260. Meanwhile, the protective circuit module 240 includes a sealing valve 248 sealing the electrolyte solution injecting inlet after the case 260 is injected with the electrolyte solution.

Unlike earlier designs for rechargeable batteries, the rechargeable batteries according to the embodiments of the present invention use the protective circuit module itself as a cover for the opening in the case. This results in a more compact design for the rechargeable battery that has a reduced number of components and a reduced height, allowing for a higher capacity battery that fits into a smaller space.

In the embodiments of the present invention, because the protective element IC chip is arranged within the case, the resin layer formed thereon prevents the protective element IC chip from being exposed to the electrolyte. Because the metal layer and the resin layer are attached to the circuit substrate prior to the assembly process of the rechargeable battery, the assembly process of the rechargeable battery is simplified and includes fewer steps, making the rechargeable batteries according to the embodiments of the present invention superior to earlier rechargeable batteries.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery, comprising:
a case;
an electrode assembly arranged within the case; and
a protective circuit module borne by an opening in the case to seal the electrode assembly within the case, the protective circuit module including:
a circuit substrate including a printed circuit board and an electronic component arranged on the printed circuit board; and
a metal layer borne by the circuit substrate, wherein a peripheral portion of the metal layer is attached to the case to seal the electrode assembly within.

2. The rechargeable battery of claim 1, wherein the electronic component faces the electrode assembly.

3. The rechargeable battery of claim 1, further comprising a resin layer arranged between the electrode assembly and each of the circuit substrate and the metal layer.

4. The rechargeable battery of claim 3, wherein the resin layer covers the electronic component.

5. The rechargeable battery of claim 4, further comprising lead tabs extending from the electrode assembly and through the resin layer.

6. The rechargeable battery of claim 3, wherein the protective circuit module is perforated by an electrolyte solution injecting aperture.

7. The rechargeable battery of claim 6, wherein the resin layer is perforated by an electrolyte solution injecting aperture at a location corresponding to a location of the electrolyte solution injecting aperture that perforates the protective circuit module.

8. The rechargeable battery of claim 1, the metal layer having a plate shape and being comprised of a same material as the case.

9. The rechargeable battery of claim 8, the metal layer being welded to the case.

10. The rechargeable battery of claim 1, wherein the electronic component is an integrated circuit (IC) chip arranged on a side of the circuit substrate facing the electrode assembly, the electronic component being arranged within the case and being covered by the resin layer.

11. The rechargeable battery of claim 1, the circuit substrate comprises a first plate and a second plate, the metal layer being arranged between the first plate and the second plate, the first plate and the second plate each being printed circuit boards.

12. The rechargeable battery of claim 11, the metal layer extending along a length of the circuit substrate from beyond a first end of the first and second plates to beyond a second end of the first and second plates.

13. The rechargeable battery of claim 1, the metal layer being arranged only at a periphery of the circuit substrate and having a supporting part inserted into sidewalls of the circuit substrate and a protruding part extending to an outside of sidewalls of end portions of the circuit substrate.

14. The rechargeable battery of claim 1, the metal layer being arranged on a top side of the circuit substrate, the metal layer extending along a length of the circuit substrate from beyond a first end of the circuit substrate to beyond a second end of the circuit substrate.

15. The rechargeable battery of claim 1, the circuit substrate comprises a lower molding part arranged on a bottom side of the metal layer and an upper molding part arranged on a top side of the metal layer, the metal layer having an opening corresponding to outer terminals of the rechargeable battery.

16. The rechargeable battery of claim 15, the metal layer protruding from end sidewalls of the upper and lower molding parts.

17. The rechargeable battery of claim 1, the metal layer being arranged on a lower side of the circuit substrate and being arranged only at a periphery of the circuit substrate.

18. The rechargeable battery of claim 14, further comprising an outer terminal arranged on a top side of the circuit substrate to connect to an external device, the metal layer having an aperture in a vicinity of the outer terminal to prevent electrical connection to the outer terminal.

19. A rechargeable battery, comprising:
a case;
an electrode assembly arranged within the case; and
a protective circuit module joined with an opening in the case, the protective circuit module including:
a circuit substrate including a printed circuit board including electrical traces arranged thereon and a protective element IC chip arranged on the printed circuit board; and
a metal layer joined to the circuit substrate.

20. The rechargeable battery of claim 19, further comprising a resin layer arranged between the electrode assembly and the protective circuit module and covering the protective element IC chip.
